(19) United States
(12) Patent Application Publication
(10) Pub. No.: US 2025/0193078 A1
(43) Pub. Date: Jun. 12, 2025

(54) COMMUNICATION CONTROL DEVICE, COMMUNICATION CONTROL METHOD, AND COMMUNICATION CONTROL PROGRAM

(71) Applicants: TOYOTA JIDOSHA KABUSHIKI KAISHA, Toyota-shi, Aichi-ken (JP); SUMITOMO ELECTRIC INDUSTRIES, LTD., Osaka-shi (JP); SUMITOMO WIRING SYSTEMS, LTD., Yokkaichi-shi (JP); AUTONETWORKS TECHNOLOGIES, LTD., Yokkaichi-shi (JP)

(72) Inventors: Yasuhiro YAMASAKI, Nishin-shi (JP); Kunihiro MIYAUCHI, Toyota-shi (JP); Hideki GOTO, Okazaki-shi (JP); Ikuyoshi OTAKE, Toyota-shi (JP); Yusuke YAMAMOTO, Osaka-shi (JP); Tatsuya IZUMI, Osaka-shi (JP); Hideyuki TANAKA, Osaka-shi (JP); Kenta OGATA, Osaka-shi (JP); Yoshitaka KIKUCHI, Yokkaichi-shi (JP); Hirofumi URAYAMA, Yokkaichi-shi (JP); Darmawan GO, Yokkaichi-shi (JP)

(73) Assignees: TOYOTA JIDOSHA KABUSHIKI KAISHA, Toyota-shi, Aichi-ken (JP); SUMITOMO ELECTRIC INDUSTRIES, LTD., Osaka-shi (JP); SUMITOMO WIRING SYSTEMS, LTD., Yokkaichi-shi (JP); AUTONETWORKS TECHNOLOGIES, LTD., Yokkaichi-shi (JP)

(21) Appl. No.: 18/842,121

(22) PCT Filed: Feb. 10, 2023
(86) PCT No.: PCT/JP2023/004646

§ 371 Date: Aug. 28, 2024

(30) Foreign Application Priority Data
Mar. 10, 2022 (JP) 2022-037539

(51) Int. Cl. H04L 41/0859; H04L 41/0681

(52) U.S. Cl. CPC H04L 41/0863; H04L 41/0681

(57) ABSTRACT

Provided is an ECU serving as a communication control device including: a memory; and a processor coupled to the memory, wherein the processor is configured to: perform a process pertaining to changing settings of a network; output, to a communication device connected to the network, a notification that a change to the settings of the network has been completed; and upon receiving a communication error in regard to communication on the network from the communication device conducting communication according to the change to the settings of the network based on the notification, perform a process for returning changed settings of the network to a pre-change state.

### TECHNICAL FIELD

The present disclosure relates to a communication control device, a communication control method, and a communication control program.

### BACKGROUND ART

Software-defined networking (SDN), which changes the configuration of a network by software-defined settings without changing hardware configurations, is increasingly being utilized. For example, JP-A No. 2017-169044 discloses a setting device that operates a network and at the same time contributes to performing updates to the settings of communication devices that configure the network.

### SUMMARY OF INVENTION

### Technical Problem

When a communication device connected to a network checks continuity with a communication partner after the network settings have been changed, there may be cases where it is unable to communicate normally, resulting in a communication error.

The present disclosure has been devised in view of the above point, and it is an object thereof to provide a communication control device, a communication control method, and a communication control program that ensure that further communication errors do not occur when a communication error occurs after network settings have been changed.

### Solution to Problem

A communication control device pertaining to a first aspect of the present disclosure includes a setting unit that performs a process pertaining to changing settings of a network, an output unit that outputs, to a communication device connected to the network, a notification that a change to the settings of the network has been completed, and a control unit that, upon receiving a communication error in regard to communication on the network from the communication device conducting communication according to the change to the settings of the network based on the notification, performs a process for returning changed settings of the network to a pre-change state.

According to the first aspect of the present disclosure, when a communication error occurs after the network settings have been changed, it can be ensured that further communication errors do not occur by returning the network settings to their pre-change state.

A communication control device pertaining to a second aspect of the present disclosure is the communication control device pertaining to the first aspect, wherein the control unit determines that the change to the settings of the network is valid in a case in which the control unit does not receive a communication error from the communication device for a predetermined amount of time after changing the settings of the network.

According to the second aspect of the present disclosure, when a communication abnormality is not detected after the network settings are changed, the network can be controlled based on the judgment that the change to the network settings is valid.

A communication control device pertaining to a third aspect of the present disclosure is the communication control device pertaining to the second aspect, wherein the control unit notifies an external device that the change to the settings of the network is valid.

According to the third aspect of the present disclosure, the external device can be made aware that the change to the network settings is valid.

A communication control device pertaining to a fourth aspect of the present disclosure is the communication control device pertaining to any of the first aspect to the third aspect, wherein the control unit performs, with respect to the communication device connected to the network on which the control unit made the change to the settings of the network that was the cause of the communication error from the communication device, a process for returning the settings of the network to the pre-change state.

According to the fourth aspect of the present disclosure, the range in which the network settings are returned to their pre-change state can be minimized.

A communication control device pertaining to a fifth aspect of the present disclosure is the communication control device pertaining to any of the first aspect to the fourth aspect, wherein the communication error is at least one of being unable to confirm continuity with a communication device to which communication is addressed, being unable to conduct communication in a predetermined period, being unable to conduct communication by a predetermined protocol, or being unable to conduct communication because a predetermined port is not open.

According to the fifth aspect of the present disclosure, a predetermined state in which communication is not possible can be judged to be a communication error.

A communication control device pertaining to a sixth aspect of the present disclosure is the communication control device pertaining to any of the first aspect to the fifth aspect, wherein the control unit requests that a server that distributed software that was responsible for changing the settings of the network returns the software to a pre-update state.

According to the sixth aspect of the present disclosure, the software can be rolled back to a state in which communication errors do not occur.

A communication control device pertaining to a seventh aspect of the present disclosure is the communication control device pertaining to any of the first aspect to the sixth aspect, further including a monitoring unit that regularly monitors whether there is a notification of a communication error from the communication device connected to the network, wherein the control unit, in response to a detection of a notification of a communication error by the monitoring unit, performs, with respect to the communication device that was a target of the change to the settings of the network, a process for returning the settings of the network to the pre-change state.

According to the seventh aspect of the present disclosure, the occurrence of communication errors is monitored and, as a result of the monitoring, the network settings can be returned to their pre-change state when a communication error occurs.

A communication control device pertaining to an eighth aspect of the present disclosure is the communication control device pertaining to any of the first aspect to the seventh aspect, wherein the network is an in-vehicle network.

According to the eighth aspect of the present disclosure, when a communication abnormality occurs in a communication device connected to the in-vehicle network, the network settings can be returned to their pre-change state.

A communication control method pertaining to a ninth aspect of the present disclosure is a method by which a processor executes a process to perform a process pertaining to changing settings of a network, provide a notification to a communication device connected to the network that a change to the settings of the network has been completed, and upon receiving a communication error in regard to communication on the network from the communication device conducting communication according to the change to the settings of the network based on the notification, perform a process for returning changed settings of the network to a pre-change state.

According to the ninth aspect of the present disclosure, when a communication error occurs after the network settings have been changed, it can be ensured that further communication errors do not occur by returning the network settings to their pre-change state.

A communication control program pertaining to a tenth aspect of the present disclosure causes a computer to execute a process to perform a process pertaining to changing settings of a network, provide a notification to a communication device connected to the network that a change to the settings of the network has been completed, and upon receiving a communication error in regard to communication on the network from the communication device conducting communication according to the change to the settings of the network based on the notification, perform a process for returning changed settings of the network to a pre-change state.

According to the tenth aspect of the present disclosure, when a communication error occurs after the network settings have been changed, it can be ensured that further communication errors do not occur by returning the network settings to their pre-change state.

### Advantageous Effects of Invention

According to the present disclosure, there can be provided a communication control device, a communication control method, and a communication control program which, when a communication error occurs after network settings have been changed, ensure that further communication errors do not occur by returning the network settings to what they were before the change.

### BRIEF DESCRIPTION OF DRAWINGS

FIG. 1 is a diagram showing the schematic configuration of a communication system pertaining to an embodiment.

FIG. 2 is a block diagram showing hardware configurations of an ECU.

FIG. 3 is a block diagram showing an example of functional configurations of the ECU.

FIG. 4 is a block diagram showing hardware configurations of ECUs.

FIG. 5 is a block diagram showing an example of functional configurations of the ECUs.

FIG. 6 is a sequence diagram describing the operations of each of the devices of the communication system.

### DESCRIPTION OF EMBODIMENTS

An example of an embodiment of the present disclosure will be described below with reference to the drawings. It will be noted that, in the drawings, identical or equivalent constituent elements and components are denoted by identical reference signs. Furthermore, dimensional ratios in the drawings may be exaggerated for convenience of description and differ from actual ratios.

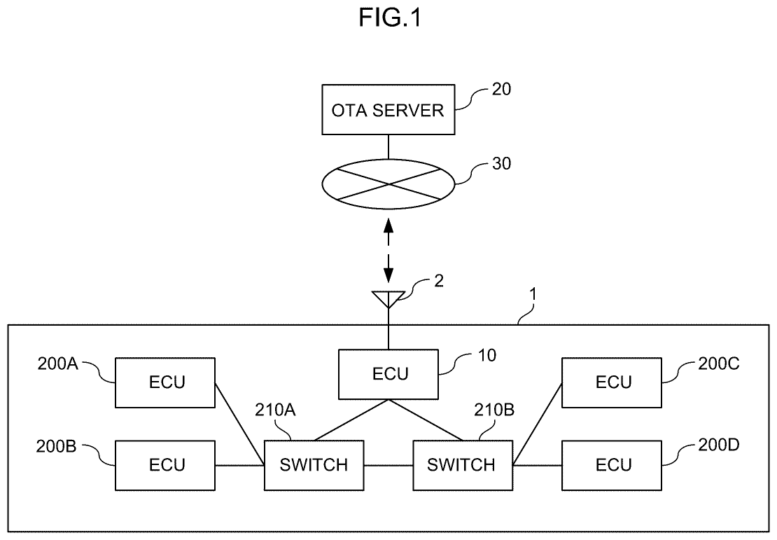

FIG. 1 is a diagram showing the schematic configuration of a communication system pertaining to the present embodiment. The communication system shown in FIG. 1 has a configuration where a vehicle 1 and an over-the-air (OTA) server 20 are connected via a network 30. The vehicle 1 includes an antenna 2 and an in-vehicle network, which is an example of a network of the present disclosure and includes electronic control units (ECUs) 10, 200A, 200B, 200C, 200D and switches 210A, 210B. The ECUs 10, 200A, 200B, 200C, 200D and the switches 210A, 210B are connected by Ethernet (registered trademark). It will be noted that the numbers of the ECUs and the switches are not limited to those of the example shown in FIG. 1 and that the mode of connection between the ECUs and the switches is not limited to that of the example shown in FIG. 1.

The ECU 10 is an ECU that controls the entire in-vehicle network. The ECU 10 communicates with the OTA server 20 via the antenna 2 to exchange various data with the OTA server 20. The ECUs 200A, 200B, 200C, 200D are ECUs for controlling different parts of the vehicle 1. For example, the ECUs 200A, 200B, 200C, 200D control the operations of devices installed in the vehicle 1, such as an engine, a motor, brakes, cameras, and lights.

Furthermore, the ECU 10 changes the configuration of the in-vehicle network by software-defined settings using SDN technology without changing the hardware configurations of the in-vehicle network. That is, when changing the configuration of the in-vehicle network, rather than unplugging and plugging cables or individually setting the individual switches 210A, 210B, the ECU 10 operates the switches 210A, 210B by software control utilizing OpenFlow for example. Specifically, the ECU 10 sets, by software control, destinations of packets sent from each of the ECUs to the switches 210A, 210B. The switches 210A, 210B pass or discard the packets based on content set by the ECU 10.

The OTA server 20 is a server for updating software in each of the ECUs of the vehicle 1. When an update becomes available for the software stored in each of the ECUs of the vehicle 1, the OTA server 20 sends the updated software to the vehicle 1. When updating the software stored in each of the ECUs of the vehicle 1, the OTA server 20 may automatically send the software to the vehicle 1 or the OTA server 20 may send the software to the vehicle 1 based on an instruction from a user riding in the vehicle 1.

When an update to the software of the ECUs connected to the in-vehicle network occurs, there may be cases where communication settings are designated by the updated software so that the ECUs conduct new communication with another ECU of the in-vehicle network. For example, there may be a case where, as a result of the software being updated in the ECU 200A, the ECU 200A starts newly communicating with the ECU 200C via the switches 210A, 210B. The ECU 10 changes the communication settings of the switches 210A, 210B when an update to the software of the ECUs connected to the in-vehicle network occurs.

However, there is the potential for an ECU that causes a communication error as a result of a software update to arise. For example, consider a case where software is updated for the ECU 200A to start communicating with the ECU 200D and the communication settings of the switches 210A, 210B are changed by the ECU 10 but the ECU 200A is unable to communicate with the ECU 200D even after conducting a continuity test. In such a case, the ECU 200A notifies the ECU 10 that a communication error has occurred in communication with the ECU 200D.

Therefore, when there is an ECU in which a communication error has occurred as a result of the communication settings of the switches 210A, 210B having been changed by software, the ECU 10 pertaining to the present embodiment returns the communication settings of the switches 210A, 210B to their pre-change state. Then, the ECU 10 instructs the OTA server 20 to roll back the software. When there is an ECU in which a communication error has occurred, the ECU 10 pertaining to the present embodiment can stop that ECU from causing further communication errors by returning the communication settings of the switches 210A, 210B to their pre-change state.

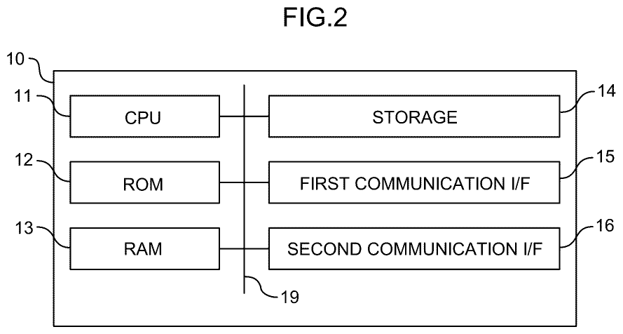

Next, hardware configurations of the ECU 10 will be described. FIG. 2 is a block diagram showing the hardware configurations of the ECU 10.

As shown in FIG. 2, the ECU 10 includes a central processing unit (CPU) 11, a read-only memory (ROM) 12, a random-access memory (RAM) 13, a storage 14, a first communication interface (I/F) 15, and a second communication interface 16. These configurations are communicably connected to each other via a bus 19.

The CPU 11 is a central arithmetic processing unit, executes various types of programs, and controls each part. That is, the CPU 11 reads programs from the ROM 12 or the storage 14 and executes the programs using the RAM 13 as a workspace. The CPU 11 controls each of the above configurations and performs various types of arithmetic processing in accordance with the programs recorded in the ROM 12 or the storage 14. In the present embodiment, the ROM 12 or the storage 14 stores a communication control program that controls communication on the in-vehicle network of the vehicle 1.

The ROM 12 stores various types of programs and various types of data. The RAM 13 temporarily stores programs or data as a workspace. The storage 14 is configured by a storage device such as flash memory and stores various types of programs, including an operating system, and various types of data.

The first communication interface 15 is an interface for communicating with the OTA server 20 and uses a wireless communication standard such as 4G, 5G, or Wi-Fi (registered trademark) for example. The second communication interface 16 is an interface for communicating with other devices such as the ECUs 200A to 200D and uses a wired communication standard such as Ethernet (registered trademark) for example.

When executing the above communication control program, the ECU 10 realizes various types of functions using the above hardware resources. Functional configurations realized by the ECU 10 will now be described.

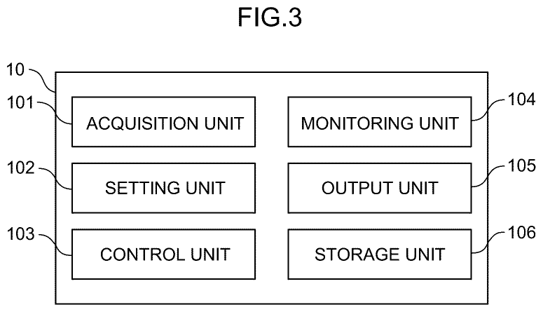

FIG. 3 is a block diagram showing an example of the functional configurations of the ECU 10.

As shown in FIG. 3, the ECU 10 has, as functional configurations, an acquisition unit 101, a setting unit 102, a control unit 103, a monitoring unit 104, an output unit 105, and a storage unit 106. Each of these functional configurations is realized by the CPU 11 reading and executing the communication control program stored in the ROM 12 or the storage 14. It will be noted that the functions of the acquisition unit 101, the setting unit 102, the control unit 103, the monitoring unit 104, the output unit 105, and the storage unit 106 may also be realized in multiple ECUs.

The acquisition unit 101 acquires data from the OTA server 20 and the ECUs 200A to 200D of the in-vehicle network. Specifically, the acquisition unit 101 acquires new software from the OTA server 20 when an update becomes available for the software executed by the ECUs 200A to 200D. Furthermore, the acquisition unit 101 acquires data for changing the communication settings of the switches 210A, 210B when it is necessary in accordance with an update to the software of the ECUs 200A to 200D.

The setting unit 102 performs communication settings on the in-vehicle network by software. For example, the setting unit 102 changes the communication settings of the switches 210A, 210B when it is necessary in accordance with an update to the software of the ECUs 200A to 200D. That is, the setting unit 102 changes the configuration of the in-vehicle network by software-defined settings. The communication settings changed by the setting unit 102 include, for example, settings relating to the paths by which the ECUs 200 can communicate with communication partners, settings relating to the opening or closing of ports, settings relating to the priority of packets to be passed, settings relating to packet queue size, settings relating to band, and settings relating to packet filtering. For example, in a case where the ECU 200D is newly added to the in-vehicle network, the setting unit 102 applies, to the switches 210A, 210B, settings for enabling the other ECUs 200A to 200C that will communicate with the ECU 200D to communicate with the ECU 200D.

The switches 210A, 210B retain the communication settings in the form of a table for example. The switches 210A, 210B reference the table to process frames or packets flowing through the in-vehicle network.

The control unit 103 controls the operation of the ECU 10 and controls the in-vehicle network. Specifically, when an update becomes available for the software executed by the ECUs 200A to 200D, the control unit 103 performs control to cause the output unit 105 to output the new software acquired by the acquisition unit 101. Furthermore, the control unit 103 performs control to cause the output unit 105 to output data necessary for the setting unit 102 to change the communication settings of the switches 210A, 210B when it is necessary in accordance with an update to the software of the ECUs 200A to 200D.

The monitoring unit 104 monitors the status of communication in the in-vehicle network. Specifically, the monitoring unit 104 monitors whether it is being notified of a communication error from each of the ECUs connected to the in-vehicle network.

The output unit 105 outputs data to the OTA server 20 and each of the devices of the in-vehicle network. The output of data from the output unit 105 is performed by control from the control unit 103.

The storage unit 106 stores various types of information such as information referenced during the operation of the ECU 10 and information used to control the in-vehicle network. Specifically, the storage unit 106 stores pre-change communication settings for returning the communication settings of the switches 210A, 210B to their original state when a communication error occurs in a certain ECU of the in-vehicle network after the communication settings of the switches 210A, 210B have been changed.

After a software update has been performed with respect to at least any of the ECUs 200A to 200D and the communication settings of the switches 210A, 210B have been changed, there is the potential for a communication error to occur in a certain ECU of the in-vehicle network. Upon confirming that it has been notified of the occurrence of a communication error, the monitoring unit 104 notifies the control unit 103 that there is an ECU 200 in which a communication error is occurring in the in-vehicle network. Upon confirming that there is an ECU 200 in which a communication error is occurring in the in-vehicle network due to the software update and the change to the communication settings, the control unit 103 requests that the OTA server 20 roll back the updated software to the pre-update software. Then, upon receiving a roll back instruction from the OTA server 20, the control unit 103 reads the pre-change communication settings stored in the storage unit 106 and performs control to return the communication settings of the switches 210A, 210B to their original state.

The control unit 103 may judge that the change to the in-vehicle network settings is valid when it does not receive a notification of the occurrence of a communication error from the ECUs 200 for a predetermined amount of time after changing the in-vehicle network settings in the switches 210A, 210B. Additionally, the control unit 103 may notify the OTA server 20 that the change to the in-vehicle network was valid. By receiving from the vehicle 1 a notification that the change to the in-vehicle network was valid, the OTA server 20 can grasp that the software update was normally completed.

By virtue of having the configurations shown in FIG. 3, the ECU 10 can return the switches 210A, 210B that were the target of the change to the network settings to their pre-change communication settings when an ECU that was not the target of the change to the network settings has caused a communication error. By returning the switches 210A, 210B to their pre-change communication settings, the ECU 10 can ensure that an ECU that was not the target of the change to the network settings does not cause a communication error.

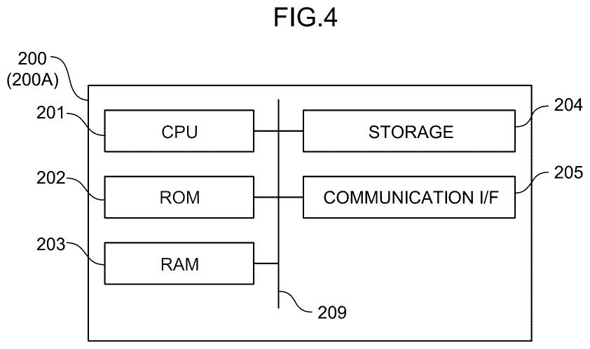

Next, hardware configurations of the ECUs 200A to 200D will be described. Below, the ECUs 200A to 200D will be collectively referred to as the ECUs 200. FIG. 4 is a block diagram showing the hardware configurations of the ECUs 200.

As shown in FIG. 4, the ECUs 200 include a CPU 201, a ROM 202, a RAM 203, a storage 204, and a communication interface (I/F) 205. These configurations are communicably connected to each other via a bus 209.

The CPU 201 is a central arithmetic processing unit, executes various types of programs, and controls each part. That is, the CPU 201 reads programs from the ROM 202 or the storage 204 and executes the programs using the RAM 203 as a workspace. The CPU 201 controls each of the above configurations and performs various types of arithmetic processing in accordance with the programs recorded in the ROM 202 or the storage 204.

The ROM 202 stores various types of programs and various types of data. The RAM 203 temporarily stores programs or data as a workspace. The storage 204 is configured by a storage device such as flash memory and stores various types of programs, including an operating system, and various types of data.

The communication interface 205 is an interface for communicating with other devices such as the ECU 10 and the other ECUs 200 and uses a wired communication standard such as Ethernet (registered trademark) for example.

When executing the above communication control program, the ECUs 200 realize various types of functions using the above hardware resources. Functional configurations realized by the ECUs 200 will now be described.

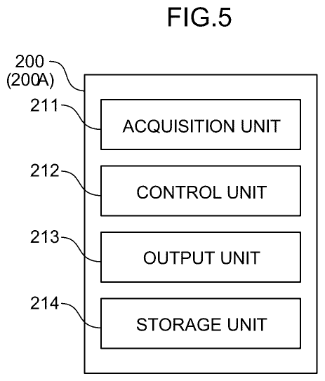

FIG. 5 is a block diagram showing an example of the functional configurations of the ECUs 200.

As shown in FIG. 5, the ECUs 200 have, as functional configurations, an acquisition unit 211, a control unit 212, an output unit 213, and a storage unit 214. Each of these functional configurations is realized by the CPU 201 reading and executing the programs stored in the ROM 202 or the storage 204.

The acquisition unit 211 acquires data from the ECU 10 and the other ECUs 200 of the in-vehicle network. Specifically, the acquisition unit 211 acquires new software from the ECU 10 when an update becomes available for the software executed by the ECUs 200.

The control unit 212 controls the operation of the ECUs 200. Specifically, when an update becomes available for the software executed by the ECUs 200, the control unit 212 performs a process to update the software of the host device with the new software acquired by the acquisition unit 211. Furthermore, when a communication error with an ECU 200 that is a communication partner occurs, the control unit 212 notifies the ECU 10 that a communication error has occurred.

The output unit 213 outputs data to the ECU 10 and the other ECUs 200 of the in-vehicle network. The output of the data from the output unit 213 is performed by control from the control unit 212.

The storage unit 214 stores various types of information such as information referenced during the operation of the ECU 10 and information used to control the in-vehicle network. Specifically, the storage unit 214 stores software executed by the ECUs 200 and data referenced by the software.

Next, the action of the communication system will be described.

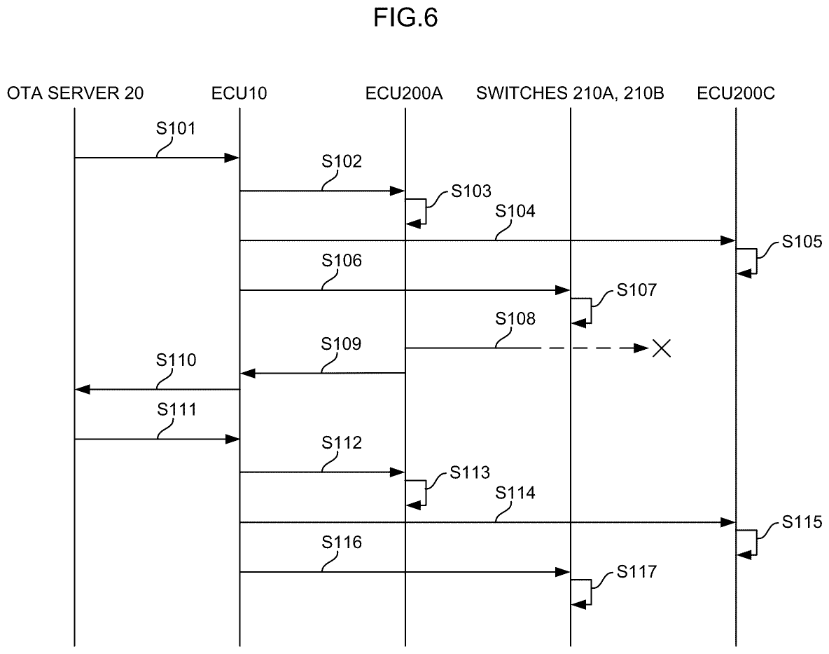

FIG. 6 is a sequence diagram describing the operations of each of the devices of the communication system. In the ECU 10, a communication control process is performed by the CPU 11 reading the communication control program from the ROM 12 or the storage 14, loading it to the RAM 13, and executing it.

The sequence diagram shown in FIG. 6 shows the operations of each of the devices when the software executed by the ECUs 200 of the in-vehicle network is updated and the communication settings of the switches 210A, 210B are changed in accordance with the software update. FIG. 6 is a sequence diagram assuming a case where, before the software update, communication between the ECU 200A and the ECU 200C is started by the communication settings of the switches 210A, 210B.

When updating the software executed by the ECUs 200 of the in-vehicle network, first, in step S101, the OTA server 20 sends software data to the vehicle 1. The software data sent from the OTA server 20 is first acquired by the ECU 10. The ECU 10 outputs the software data acquired from the OTA server 20 to the ECUs 200 that are targets of the update. Here, the ECUs 200A, 200C shall be the targets of the software update. In steps S102 and S104, the ECU 10 outputs the software data to the ECUs 200A, 200C that are the targets of the software update. In step S103, the ECU 200A updates its software using the software data sent thereto from the ECU 10. Likewise, in step S105, the ECU 200C updates its software using the software data sent thereto from the ECU 10.

Furthermore, in order to update the communication settings of the switches 210A, 210B in accordance with the software update, in step S106, the ECU 10 outputs new communication settings information. In step S107, the switches 210A, 210B reflect the communication settings using the communication settings information sent thereto from the ECU 10. For example, the ECU 10 updates the communication settings of the switches 210A, 210B so as to enable communication between the ECU 200A and the ECU 200C because of the update to the software of the ECUs 200A, 200C.

Communication should be possible between the ECU 200A and the ECU 200C as a result of the communication settings of the switches 210A, 210B being updated. Thus, in step S108, the ECU 200A performs a continuity check with the ECU 200C. However, there may be cases where communication cannot be conducted between the ECU 200A and the ECU 200C for reasons such as wrong content in the communication settings of the switches 210A, 210B. In step S109, the ECU 200A notifies the ECU 10 that a communication error with the ECU 200C has occurred.

When the ECU 10 acquires the notification of the occurrence of a communication error sent from the ECU 200A, in step S110, the ECU 10 sends to the OTA server 20 an indication that a communication error has occurred as a result of having updated the software in the ECUs 200A, 200C and having changed the communication settings of the switches 210A, 210B. When the ECU 10 sends to the OTA server 20 the indication that a communication error has occurred, the ECU 10 also sends a reason code, which is information about the cause of the occurrence of the communication error. The reason code information is information indicating the kind of communication error that has occurred and the ECU in which it occurred. Examples of the content of the communication error specifically include content about a frame or packet that was sent to a communication partner but for which a response was not received from that communication partner. The content of the communication error may, for example, be at least any of being unable to confirm continuity with a communication device to which communication is addressed, being unable to conduct communication in a predetermined period, being unable to conduct communication by a predetermined protocol, and being unable to conduct communication because a predetermined port is not open.

In step S111, the OTA server 20 that has received the indication that a communication error has occurred sends a rollback instruction to the vehicle 1 in step S111. “Rollback” refers to a return to the pre-update software. When the rollback instruction is sent from the OTA server 20, the ECUs 200A, 200C use the pre-update software data they had been retaining to return the software to its pre-update state.

When the ECU 10 receives the rollback instruction from the OTA server 20, the ECU 10 outputs the rollback instruction to the ECUs 200 that are the rollback targets. Here, the ECUs 200A, 200C are the software rollback targets. In steps S112 and S114, the ECU 10 outputs the rollback instruction to the ECUs 200A, 200C that are the software rollback targets. In step S113, the ECU 200A rolls back its software based on the instruction from the ECU 10. Likewise, in step S115, the ECU 200C rolls back its software based on the instruction from the ECU 10. Furthermore, together with the software rollback, in step S116, the ECU 10 instructs the switches 210A, 210B to return their communication settings to their pre-change state. In step S117, the switches 210A, 210B return their communication settings to their pre-change state.

Upon receiving the indication of the occurrence of the communication error and the reason code from the ECU 10, the OTA server 20 sends to the vehicle 1 software that has been fixed so that communication errors do not occur based on the content of the reason code. Here, the distribution targets of the fixed software are not limited to the ECUs 200A, 200C and may also include the ECU 200D that is unrelated to the communication error. The flow from when the software is sent from the OTA server 20 to when the software is updated in the ECUs 200 is the same as that from step S101 to step S105 described above, so detailed description thereof will be omitted. Furthermore, the ECU 10 executes a process for updating the communication settings of the switches 210A, 210B in accordance with the software update.

As described above, according to the embodiment of the present disclosure, when an ECU causes a communication error after the network settings have been changed, the communication settings of the switches that were the targets of the change to the network settings can be returned to their pre-change state. By returning the communication settings of the switches that were the targets of the change to the network settings to their pre-change state, the ECU 10 can ensure that the ECUs do not cause further communication errors.

In the above embodiment, a case where the OTA server 20 distributes the software was described, but in a case where the OTA server 20 does not distribute the software, upon acquiring the detection of a communication abnormality by the ECUs 200 the ECU 10 executes a process to return the communication settings of the switches 210A, 210B to their pre-change state.

The present disclosure is also applicable to changing communication settings for when an ECU is newly connected to the in-vehicle network and enabling the newly connected ECU to communicate with the other ECUs. Furthermore, although in the above embodiment an example relating to changing communication settings in an in-vehicle network that is a network constructed in a vehicle was described, the present disclosure is not limited to this example. The present disclosure can be applied to all networks whose configuration is changed by software-defined settings.

It will be noted that the communication control process that the CPU executed by reading software (a program) in each of the above embodiments may also be executed by various types of processors other than a CPU. Examples of processors in this case include programmable logic devices (PLDs) whose circuit configuration can be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, the communication control process may be executed by one of these various types of processors or may be executed by a combination of two or more processors of the same type or different types (e.g., plural FPGAs, and a combination of a CPU and an FPGA, etc.). Furthermore, the hardware structures of these various types of processors are more specifically electrical circuits in which circuit elements such as semiconductor elements are combined.

Furthermore, in each of the above embodiments, an aspect was described where the program for the communication control process is stored (installed) beforehand in a ROM or a storage, but the program is not limited to this. The program may also be provided in a form in which it is recorded in a non-transitory recording medium such as a compact disk read-only memory (CD-ROM), a digital versatile disk read-only memory (DVD-ROM), and a universal serial bus (USB) memory. Furthermore, the program may also take a form in which it is downloaded via a network from an external device.

### (Supplementary Item 1)

A communication control device including a processor, the processor executing a process to:
perform a process pertaining to changing the settings of a network;
output, to a communication device connected to the network, a notification that a change to the network settings has been completed; and
upon receiving a communication error in regard to communication on the network from the communication device conducting communication according to the change to the network settings based on the notification, perform a process for returning the changed network settings to their pre-change state.

### (Supplementary Item 2)

The communication control device of supplementary item 1, wherein the processor judges that the change to the network settings is valid when it does not receive a communication error from the communication device for a predetermined amount of time after changing the network settings.

### (Supplementary Item 3)

The communication control device of supplementary item 2, wherein the processor notifies an external device that the change to the network settings is valid.

### (Supplementary Item 4)

The communication control device of any one of supplementary items 1 to 3, wherein the processor performs, with respect to the communication device connected to the network on which it made the change to the network settings that was the cause of the communication error from the communication device, a process for returning the network settings to their pre-change state.

### (Supplementary Item 5)

The communication control device of any one of supplementary items 1 to 4, wherein the communication error is at least any of being unable to confirm continuity with a communication device to which communication is addressed, being unable to conduct communication in a predetermined period, being unable to conduct communication by a predetermined protocol, and being unable to conduct communication because a predetermined port is not open.

### (Supplementary Item 6)

The communication control device of any one of supplementary items 1 to 5, wherein the processor requests that a server that distributed software that was responsible for changing the network settings return the software to its pre-update state.

### (Supplementary Item 7)

The communication control device of any one of supplementary items 1 to 6, further including a monitoring unit that regularly monitors whether there is a notification of a communication error from the communication device connected to the network, wherein the control unit, in response to a detection of a notification of a communication error by the monitoring unit, performs, with respect to the communication device that was the target of the change to the network settings, a process for returning the network settings to their pre-change state.

### (Supplementary Item 8)

The communication control device of any one of supplementary items 1 to 7, wherein the network is an in-vehicle network.

The disclosure of Japanese Patent Application No. 2022-037539 is incorporated in its entirety herein by reference.

All documents, patent applications, and technical standards mentioned in this specification are incorporated herein by reference to the same extent as if each individual document, patent application, or technical standard were specifically and individually indicated to be incorporated by reference.

1. A communication control device, comprising:
a memory; and
a processor coupled to the memory, wherein the processor is configured to:
perform a process pertaining to changing settings of a network;
output, to a communication device connected to the network, a notification that a change to the settings of the network has been completed; and
upon receiving a communication error in regard to communication on the network from the communication device conducting communication according to the change to the settings of the network based on the notification, perform a process for returning changed settings of the network to a pre-change state.

2. The communication control device of claim 1, wherein the processor is further configured to determine that the change to the settings of the network is valid in a case in which the control unit does not receive a communication error from the communication device for a predetermined amount of time after changing the settings of the network.

3. The communication control device of claim 2, wherein the processor is further configured to notify an external device that the change to the settings of the network is valid.

4. The communication control device of any one of claim 1, wherein the processor is further configured to perform, with respect to the communication device connected to the network on which the processor made the change to the settings of the network that was the cause of the communication error from the communication device, a process for returning the settings of the network to the pre-change state.

5. The communication control device of any one of claim 1, wherein the communication error is at least one of being unable to confirm continuity with a communication device to which communication is addressed, being unable to conduct communication in a predetermined period, being unable to conduct communication by a predetermined protocol, or being unable to conduct communication because a predetermined port is not open.

6. The communication control device of any one of claim 1, wherein the processor is further configured to request the control nit us that a server that distributed software that was responsible for changing the settings of the network returns the software to a pre-update state.

7. The communication control device of claim 1, wherein the processor is further configured to regularly monitor whether there is a notification of a communication error from the communication device connected to the network, wherein the processor, in response to a detection of a notification of a communication error by the processor, is further configured to perform, with respect to the communication device that was a target of the change to the settings of the network, a process for returning the settings of the network to the pre-change state.

8. The communication control device of any one of claim 1, wherein the network is an in-vehicle network.

9. A communication control method by which a processor executes a process to:
perform a process pertaining to changing settings of a network;
provide a notification to a communication device connected to the network that a change to the settings of the network has been completed; and
upon receiving a communication error in regard to communication on the network from the communication device conducting communication according to the change to the settings of the network based on the notification, perform a process for returning changed settings of the network to a pre-change state.

10. A non-transitory computer-readable medium storing instructions that, when executed by one or more processors of a device, cause the device to:
perform a process pertaining to changing settings of a network;
provide a notification to a communication device connected to the network that a change to the settings of the network has been completed; and
upon receiving a communication error in regard to communication on the network from the communication device conducting communication according to the change to the settings of the network based on the notification, perform a process for returning changed settings of the network to a pre-change state.
